(19) United States
(12) Patent Application Publication
(10) Pub. No.: US 2022/0108583 A1
(43) Pub. Date: Apr. 7, 2022

(54) AUTOMATED, MODULAR AND COMPACT, ADDRESSABLE OBJECT STORAGE DEVICE

(71) Applicant: OUIDROP, Bordeaux (FR)

(72) Inventor: Thibault Soulier, Bordeaux (FR)

(21) Appl. No.: 17/428,225

(22) PCT Filed: Nov. 22, 2019
(86) PCT No.: PCT/EP2019/082299

§ 371 Date: Aug. 3, 2021

(30) Foreign Application Priority Data
Feb. 5, 2019 (FR) 1901108

(51) Int. Cl. G07F 17/12; G07F 11/16

(52) U.S. Cl. CPC G07F 17/12; G07F 11/165

(57) ABSTRACT

The invention relates to a device for storing at least one object OB, with a front face (2), comprising at least one level (L0, L1), characterized in that it comprises: —mechanical means for depositing and retrieving (10) the at least one object OB, —means for receiving the at least one object OB, —mechanical means for transferring the means for receiving said at least one object OB, —mechanical means for storing the means for receiving said at least one object OB, and—mechanical and software means (50) for identifying an owner seeking to deposit or retrieve the at least one object OB.

The invention relates to an automated, modular and compact, addressable object device, in particular for use as a locker. Said device can comprise tiered modules. The present invention is described in an application as a locker, but the applications could also be the storage of specific personal equipment such as medical equipment, safety equipment, and sensitive and fragile devices, using the same storage device. The aim is to provide a storage device which comprises mechanical deposition means, means for storing and retrieving at least one object OB, mechanical means for transferring said at least one object OB, mechanical means for storing said at least one object OB and mechanical and software means for identifying an owner seeking to store or retrieve the at least one object OB.

Such a storage device is advantageously:
adaptable according to the nature of the objects OB to be stored,
movable so as to be able to position said device in different locations for temporary events such as trade fairs, sporting events, conferences or other ephemeral needs,
modular according to the necessary storage volumes. “Modular” is understood to mean industrial modularity, that is to say “modulated and used,” similar to “plug and play,” a very significant Anglo-Saxon formulation regarding the absence of intervention at the heart of a device, in this case by avoiding interventions from the point of view of the mechanics of the various means of the storage device and interventions from the point of view of the software, as will be discussed below. The only interventions are interventions by mechanical and wire connections.

The storage device includes movements of different elements and the specific feature is to provide only linear movements along the three axes: X, Y and Z.

According to the present invention, the storage device comprises . . . subsequent introduction of part of the claims by AQUINOV before filing

The present invention is now described with the aid of an embodiment which is solely illustrative and in no way limits the scope of the invention, and on the basis of the accompanying illustrations, in which:

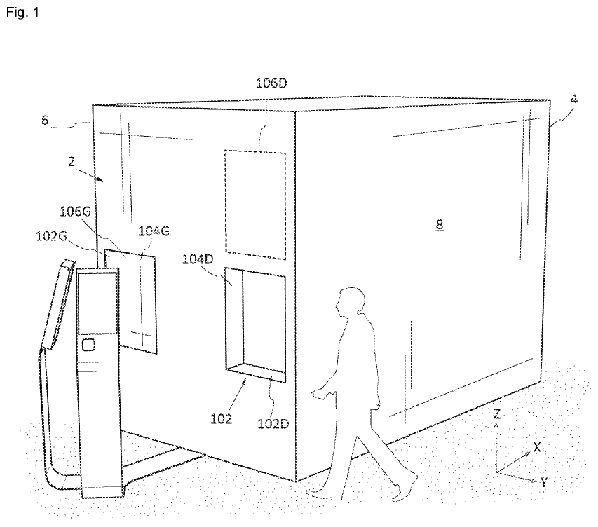

FIG. 1 is a simplified perspective view of the device for storing at least one object OB according to the present invention, in use.

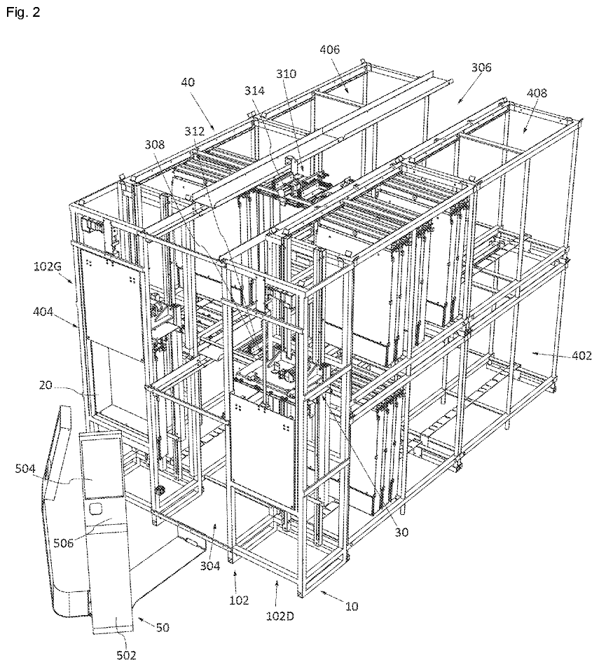

FIG. 2 is a perspective view of the structure of the device for storing at least one object OB, with the cover panels removed,

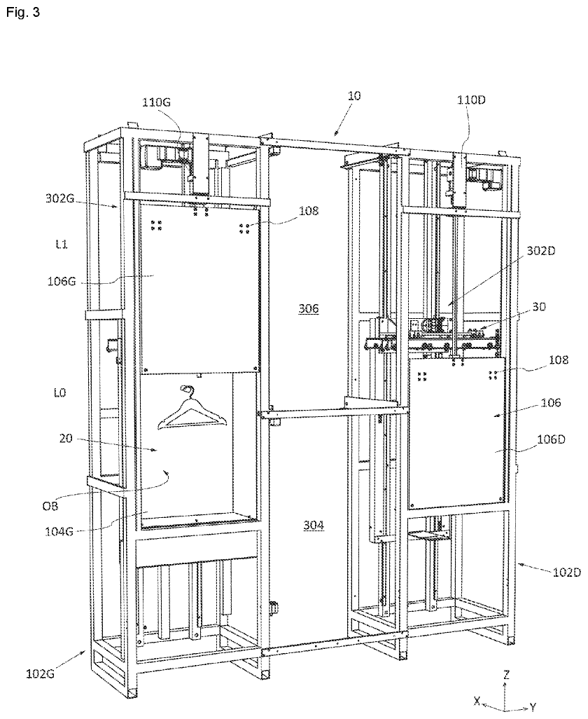

FIG. 3 is an isolated perspective view of a first part of the mechanical transfer means,

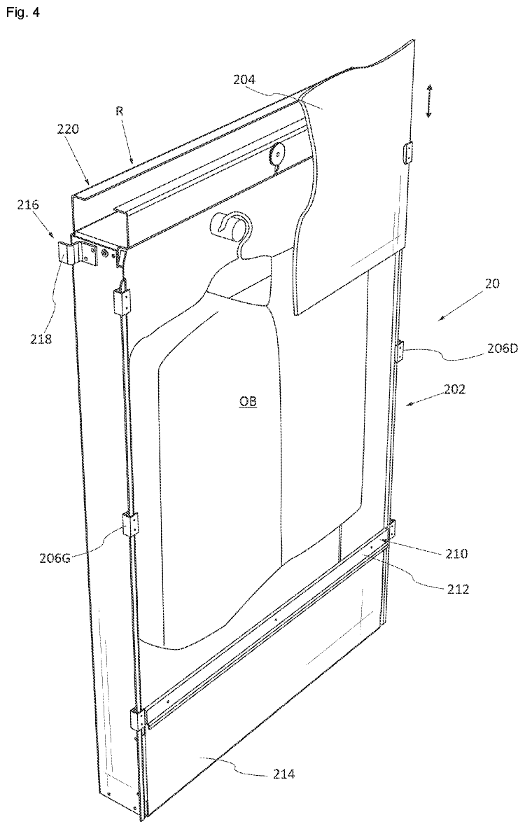

FIG. 4 is an isolated perspective view of the means for receiving an object OB,

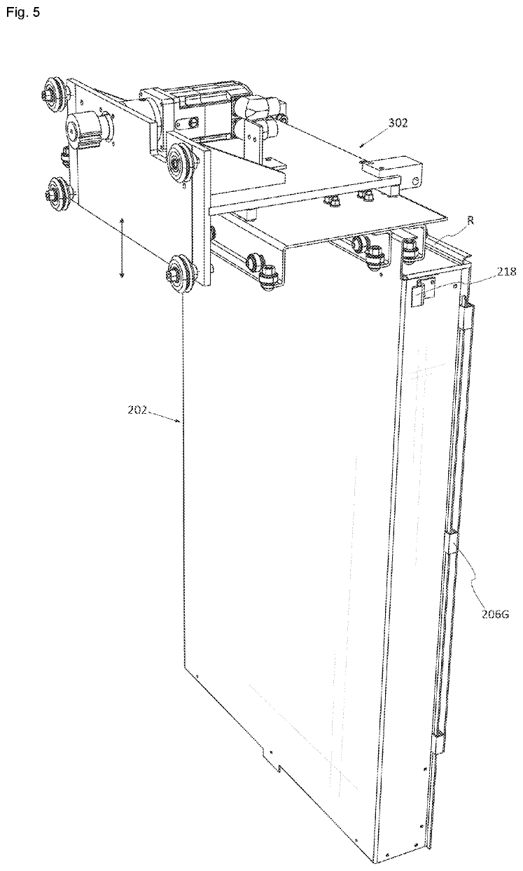

FIG. 5 is a detailed view of the driving means of the first transfer means,

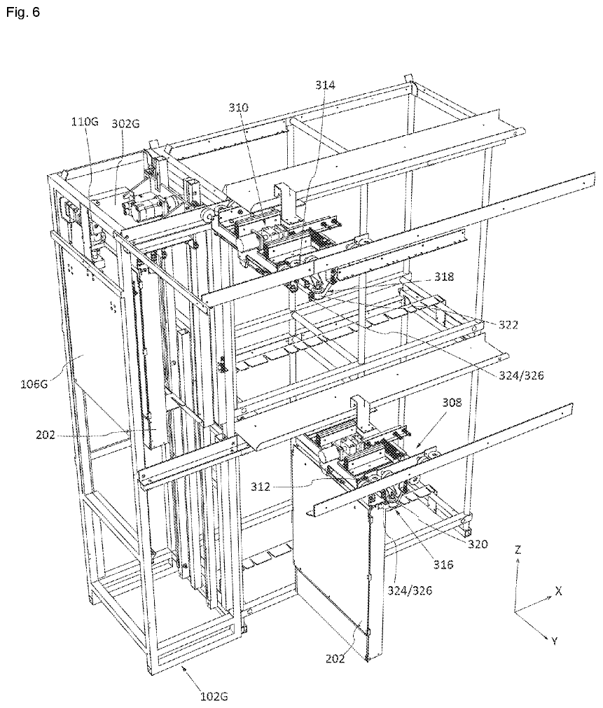

FIG. 6 is a perspective view of a second part of the mechanical transfer means,

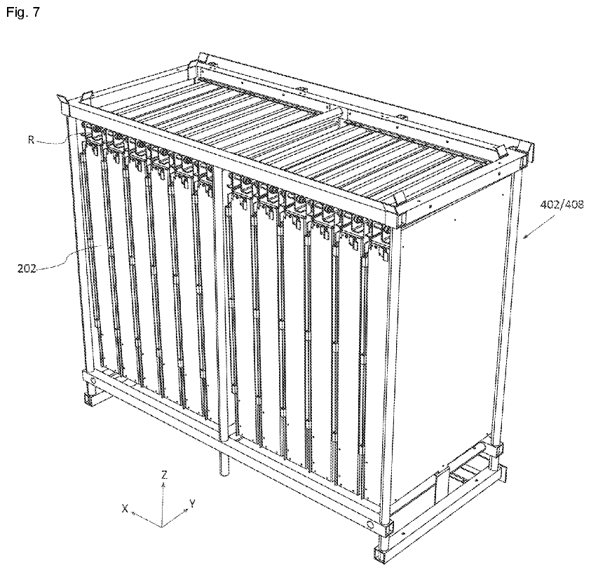

FIG. 7 is an isolated perspective view, in detail, of the storage means.

The storage device according to the present invention comprises, in its main embodiment, a number of parts which are assembled and cooperate with one another. The device according to the present invention is illustrated in the various figures and comprises two levels, a level L0 on the ground and a superimposed floor at level L1. The storage device is described according to an orthonormal X, Y and Z coordinate system and has the general shape of a parallelepiped. As can be seen in FIG. 1, the front face 2 is the origin. The direction of the X axis is perpendicular to this front face 2, with the + direction going from the front face 2 to the rear face 4. The Y axis is oriented perpendicularly to the X axis in the horizontal plane, with the + direction being from the left face 6 to the right face 8 of the drawing. The Z axis is oriented vertically, perpendicularly to the XY plane, and the + direction is from bottom to top. The directions will therefore be either positive or negative depending on the part described. As shown in FIG. 2, the storage device according to the present invention comprises a metal framework, with this type of metal framework assembly being well known as such, and it being possible to make the connections with removable connections such as screw/nut, snap-fitting or keyed connections, or with fixed connections such as welding to achieve a welded structure, and this in no way modifies the invention.

The storage device according to the present invention, see FIG. 2, comprises:
mechanical means 10 for depositing and retrieving at least one object OB,
means 20 for receiving the at least one object OB,
mechanical means 30 for transferring the means 20 for receiving said at least one object OB,
mechanical means 40 for storing the means 20 for receiving said at least one object OB, and
mechanical and software means 50 for directing and identifying an owner seeking to deposit or retrieve the at least one object OB.

In the following description, an object OB is understood to mean goods and personal items such as bags and clothing in the case of a locker.

The example of the locker is also used in a non-limiting manner.

The mechanical means 10 for depositing and retrieving an object OB by an owner, shown in FIGS. 2 and 3, comprise a metal framework defining at least one station 102, in this case two stations, a first, left-hand deposition and retrieval station 102G and a second, right-hand deposition and retrieval station 102D, both of which can be accessed on the front face 2 of the storage device. These two deposition and retrieval stations 102G and 102D are strictly identical in design and function and are symmetrically arranged on the front face. Each deposition and retrieval station 102G and 102D has an opening 104G and 104D which is made in the metal framework and is in each case provided with a shutter 106G and 106D. Each shutter is a sash shutter and can assume, in each case independently or simultaneously, two positions, one fully closed or the other fully open. The translational direction of the sash movement is +Z/−Z. These shutters 106G and 106D can advantageously be mounted with an upper pair and a lower pair of guide means, for example rollers which are mounted on the side edges of said shutters and roll in vertical rails or sliding shoes in a rail with an anti-friction material. In particular, each slide has an offset d toward the rear, in line with the upper pair of rollers when the shutter is in the down position. Thus, during the upward vertical translation, from the start of the translation, each shutter 106 undergoes a displacement of a value d along the X axis, thus from the front to the rear. Each shutter 106 comprises, in the upper part, two translational drive pins 108, said pins projecting on the rear face of each shutter and being oriented in the X direction. Instead of a slide with an offset and fixed pins, the slide can be straight and the fixed pins 108 are replaced by movable pins, namely a plunger of a solenoid which can be moved between a basic retracted position, under the effect of a return spring, and an operational projecting position when the solenoid is energized, in a known manner. Each shutter 106G and 106D is associated with its own driving means 110G and 110D, for example a worm and a threaded sleeve mounted on the worm and secured to said shutter. Such an arrangement is also well known in itself and makes it possible, by rotation of the worm, to cause the sleeve to translate and therefore to operate the shutter associated with said sleeve. Limit switches, force limiters and other safety accessories are normally associated with these driving means, in accordance with the applicable regulations and standards.

The means 20 for receiving the at least one object OB are in the form of containers 202. Such containers are shown in FIG. 4. These containers 202 have the same dimensions in height along the Z axis, in width along the Y axis and identical or variable depths along the X axis. The volumes of the containers may therefore all be identical V, but there may also be different volumes V1, V2 . . . , depending on the needs and the applications. These containers each comprise six faces, including a front face 204, oriented along the −X axis. This front face 204 is movable in vertical translation relative to the other five faces. A suitable assembly which allows sliding occurs with slides 206G and 206D which are secured to the right 208D and left 208G walls of the container 202, or with slide portions in the embodiment shown. A stop 210, advantageously a third slide 212, which is arranged in the lower part and is secured to the lower part 214 ensures a limitation of the downward translation. When the movable front face 204 bears against the stop 210, the container is closed, and when the movable front face 204 is translated upward, access to the interior volume V of the container 202 is made possible. The front face 204 naturally bears against the stop by its own weight. These containers 202 are completed by fastening means 216. These fastening means 216 comprise stops 218 which are arranged at the edge of the container and are symmetrical so as to allow fastening on each side. Advantageously, each container comprises suspension means 220 in the upper part, in this case a rail R, with a profile suitable for rolling on rollers. This rail R is capable of rolling on rollers. In addition, each front face 204 comprises two gripping holes formed at the top, on each side, so as to receive the translational drive pins 108 or the plungers in the case of a solenoid, the operation of which will be explained below.

The mechanical means 30 for transferring the means 20 for receiving the at least one object OB are shown in FIGS. 2 and 4 in particular and comprise two elevators 302G and 302D, each arranged, respectively, within the first, left-hand deposition and retrieval station 102G and in the second, right-hand deposition and retrieval station 102D. The sole purpose of these elevators is to position each of the receiving means 20, in this case each of the containers 202, at level L0 or level L1, in the embodiment chosen as an example which comprises two levels. The mechanical transfer means 30 comprise a lower central corridor 304 at level L0 and an upper central corridor 306 at level L1. Each corridor is oriented in the direction of the X axis, for each level. For each level L0 and L1, the mechanical transfer means 30 comprise a shuttle 308 and 310, respectively, allowing in particular translational transfer movements in the X, −X directions in each of said corridors. Each shuttle 308, 310 comprises rolling means, in this case rollers and a motor with a rack, which can roll on the welded structure. A specific drive 312, 314 for each shuttle 308, 310 allows a controlled indexed movement, in particular by virtue of a well-known rack-and-pinion drive.

The mechanical means 30 for transferring the receiving means 20 further comprise on-board means for loading and unloading a container 202, respectively on-board loading/unloading means 316 for level L0 and on-board loading/unloading means 318 for level L1. Each loading/unloading means 316, 318 is supported by the corresponding shuttle 308, 310. These loading/unloading means 316, 318 each comprise rollers intended to receive the rail R of a container 202. In addition, means 320, 322 for moving the containers in translation are provided to move each container transversely along the Y axis. According to a preferred but non-limiting embodiment of the invention, these translational movement means 320, 322 comprise a motorized and indexed belt, provided with two drive dogs 324, 326 that are secured to said belt. These drive dogs are able to cooperate by bearing against the fastening means 216 of the containers, as shown in FIG. 6. As the belt rotates, the container 202 is translated along the Y axis.

The storage device according to the present invention also comprises mechanical means 40 for storing the means 20 for receiving said at least one object OB. These mechanical storage means 40 are arranged on either side of each corridor 304, 306 and at each level, resulting in 4 storage modules 402, 404, 406, 408 in the embodiment shown in FIGS. 2 and 7. The storage modules are advantageously produced in a welded structure. These modules each comprise roller ramps which are parallel to each other and suitably spaced to receive the receiving means 20, in this case the containers 202. These roller ramps are oriented in the +Y −Y directions, closed on the outer side, and lead into each corridor. These roller ramps are intended to receive the rails R of the containers 202. Particularly advantageously, the ramps are slightly inclined along the Z axis, with the opening end on the corridor side being higher than the end on the outer side. The containers 202 are thus held by their own weight against the outer side. In the case of a storage device using containers 202 of different volumes and therefore of different depths, the spacing of the ramps is adapted to the depth of each container and to the number of containers of each depth. Each on-board loading/unloading means, 316 for level L0 and 318 for level L1, can thus load and unload a container 202 on a roller ramp of one of the storage modules 402, 404, 406, 408.

The storage device according to the present invention comprises mechanical and software means 50 for directing and identifying an owner seeking to deposit or retrieve the at least one object OB. These mechanical and software identification means 50 comprise, for example, a terminal 502 with a control screen 504, such as a touch screen, and also comprise a programmable controller 506 which is advantageously integrated into the terminal, and possibly linked to a remote operational center for the purpose of maintenance or the resolution of a remote problem, for example. The control screen 504 comprises a menu and means for allowing the identification of an owner of an object OB, for example a biometric parameter, or means for issuing a personal code, in any form, e.g. a QR code. The commands are then simple since they consist, for the owner, in requesting either the deposition or the retrieval of their object OB. During the deposition, the programmable controller 506 provides a means of identification by recording the biometric parameter or by supplying a code and, during the retrieval, the owner provides this means of identification to the programmable controller on request. The programmable controller 506 has the mapping of objects OB and rails R of the storage modules and the positions of the shuttles since all movements are indexed.

The operation of the device is now described, also in accordance with the figures. The following description relates to the deposition of an object OB for a locker, for example a coat and a bag. The owner presses the “deposit” button on the control screen 504 of the terminal 502, which results in the owner being asked for a biometric parameter such as a fingerprint, or in a code being issued. Optionally, when there are containers of different volumes, the owner chooses the one that suits them. Consequently, the shutter 106G and 106D of one of the openings 104G and 104D of one of the deposition and retrieval stations 102G and 102D opens, freeing the interior of a container 202, which is of the required volume if the choice is offered. The owner then places their locker items in the container 202, which can have accessories such as a hanger, a tray, etc. The owner returns to the kiosk to press “Done” and can leave the premises.

To achieve this result, the storage device according to the invention performs the following operations. As soon as the owner has indicated their request for a container 202, has optionally chosen the volume, and has been identified, the programmable controller 506 sends a shuttle 308 or 310 to look for an empty container 202, of the appropriate volume, stored on one of the roller ramps of one of the storage modules 402, 404, 406, 408. Once the shuttle is positioned in front of the container sought and identified by the controller, the belt 316, 322 of the shuttle rotates to bring a drive dog 324, 326 against the fastening means 216, in this case the dog 218 of the identified container, and translates said container from the roller ramp of the storage module onto the rollers of the shuttle concerned. The shuttle together with its container moves in the −X direction toward the deposition module and positions the rail R of the container 202 in line with the rollers of one of the elevators 110d and 110G. The belt 316, 322 rotates again in the appropriate direction depending on whether the container is to be deposited at the right-hand 102D or left-hand 102G deposition and retrieval station for an object OB. The belt, via its drive dogs, pushes the container by rolling its rail R toward the rollers of the corresponding elevator, 302G or 302D. The elevator descends from level L1 or remains at level L0 if it is already there. Then, once the container is positioned in front of an opening 104G or 104D, the shutter 106G or 106D of this opening 104G or 104D of the deposition and retrieval station 102G or 102D concerned opens. When the shutter concerned is driven upward, it also drives the movable front face 204 of the container 202 into place by means of the two translational drive pins 108, said pins projecting on the rear face of each shutter and cooperating with the gripping holes formed in the front face 204. The opening concerned is then cleared and access to the interior volume of the container 202 is provided to the owner. The owner can leave their object OB there, in this case their locker items.

It is possible to provide all the necessary safeguards for said device, and these safeguards are within the reach of a person skilled in the art. Thus, a sensor (not shown) can detect incorrect positioning of the object OB in the container, for example the coat sticking out in the case of a locker. Likewise, when the shutter is closed, if a third party or the user puts their hands and arms back into the opening at the last moment, a detector causes the shutter to move upward and in all cases a force sensor limits the force exerted.

For retrieval, the reverse operations are carried out as soon as the user has provided their biometric or coded identification to the terminal.

It is also possible to optimize the storage device using the control software of the programmable controller. For example, in the case of containers of different volumes, the containers can be arranged according to their volumes, but in an alternating manner so that the access times are as short as possible. It is also possible for the owner to request an approximate retrieval time or storage duration at the terminal to move the container forward.

It can be seen that the device is very compact, and very accessible once the cover panels of FIG. 1 are removed. This storage device may be transportable in order to position it in different geographical locations. All that is required is a power supply connection. The device can also receive means of payment when the service is chargeable.

1. A device for storing at least one object OB, with a front face (2), comprising at least one level (L0, L1), characterized in that it comprises:
mechanical means (10) for depositing and retrieving the at least one object OB,
means (20) for receiving the at least one object OB,
mechanical means (30) for transferring the means (20) for receiving said at least one object OB,
mechanical means (40) for storing the means (20) for receiving said at least one object OB, and
mechanical and software means (50) for identifying an owner seeking to deposit or retrieve the at least one object OB.

2. The device for storing at least one object OB according to claim 1, characterized in that the mechanical means for depositing and retrieving (10) the at least one object OB comprise at least one deposition and retrieval station (102) which can be accessed on the front face (2) of the device and comprises an opening (104) provided with a shutter (106).

3. The device for storing at least one object OB according to claim 2, characterized in that each shutter (106) is a sash shutter which can assume two positions, in which the opening (104) is fully closed or fully open.

4. The device for storing at least one object OB according to claim 2, characterized in that each shutter (106) is mounted with an upper pair and a lower pair of rolling or sliding means which are mounted on the side edges of said shutter and roll or slide in vertical slides, each slide having an offset d toward the rear so that, during the upward vertical translation, said shutter undergoes a displacement, and characterized in that said shutter comprises, in the upper part, two translational drive pins (108) projecting on the rear face.

5. The device for storing at least one object OB according to claim 2, characterized in that each shutter (106) is mounted with an upper pair and a lower pair of rolling or sliding means which are mounted on the side edges of said shutter and roll or slide in vertical slides which are mounted on the side edges of said shutter, the shutter comprising a solenoid with a plunger which forms a translational drive pin (108).

6. The device for storing at least one object OB according to claim 1, characterized in that the means (20) for receiving the at least one object OB are in the form of containers (202).

7. The device for storing at least one object OB according to claim 6, characterized in that the containers (202) each comprise six faces and the front face (204) is movable in vertical translation relative to the five other faces.

8. The device for storing at least one object OB according to claim 6, characterized in that the containers (202) comprise fastening means (216) and rolling means (220) suitable for rolling on rails R.

9. The device for storing at least one object OB according to claim 4, characterized in that the front face (204) of each container (202) comprises two gripping holes formed at the top, on each side, so as to receive the translational drive pins (108) of the shutter (106).

10. The device for storing at least one object OB according to claim 2, characterized in that the mechanical means (30) for transferring the means (20) for receiving at least one object OB comprise an elevator (302) for each at least one deposition and retrieval station (102).

11. The device for storing at least one object OB according to claim 2, characterized in that the mechanical transfer means (30) comprise at least one central corridor (304, 306) per level, and one translational transfer shuttle (308, 310), in each of the corridors, per level.

12. The device for storing at least one object OB according to claim 11, characterized in that each shuttle (308, 310) comprises rolling means and on-board means for loading and unloading (316, 318) a container (202).

13. The device for storing at least one object OB, according to claim 7, characterized in that the loading/unloading means (316, 318) each comprise a roller ramp which is intended to receive a rail R of a container.

14. The device for storing at least one object OB according to claim 1, characterized in that the mechanical means (40) for storing the means (20) for receiving said at least one object (OB) comprise storage modules (402, 404, 406, 408) arranged on either side of a corridor, said modules each comprising roller ramps for receiving the rails R of containers (202).

15. The device for storing at least one object OB according to claim 1, characterized in that the mechanical and software means (50) for identifying an owner seeking to deposit or retrieve the at least one object OB comprise a terminal (502) with a control screen (504), and a programmable controller (506).
